(19) United States
(12) Patent Application Publication
(10) Pub. No.: US 2014/0253277 A1
(43) Pub. Date: Sep. 11, 2014

(54) ELECTRONIC COMPONENT

(71) Applicant: MURATA MANUFACTURING CO., LTD., Kyoto (JP)

(72) Inventor: Kaori TAKEZAWA, Nagaokakyo-shi (JP)

(73) Assignee: MURATA MANUFACTURING CO., LTD., Kyoto (JP)

(21) Appl. No.: 14/185,541

(22) Filed: Feb. 20, 2014

(30) Foreign Application Priority Data
Mar. 7, 2013 (JP) 2013-044979

(51) Int. Cl. H01F 27/28

(52) U.S. Cl. CPC H01F 27/2804
USPC 336/200

(57) ABSTRACT

A laminate formed by laminating a plurality of insulator layers. First coil conductors are provided in the laminate winding in a predetermined direction when viewed in a plan view in a direction of lamination. Second coil conductors are provided in the laminate on one side in the direction of lamination relative to the first coil conductors, winding in the predetermined direction when viewed in a plan view in the direction of lamination. First via-hole conductors connect downstream ends of the first parallel portion in the predetermined direction. Second via-hole conductors connect downstream ends of the second parallel portions in the predetermined direction. A third via-hole conductor connects the farthest of the first coil conductors on one side to the farthest of the second coil conductors on the other side in the direction of lamination. The first through third via-hole conductors are not connected in a series.

### CROSS REFERENCE TO RELATED APPLICATION

This application claims benefit of priority to Japanese Patent Application No. 2013-044979 filed on Mar. 7, 2013, the entire content of which is incorporated herein by reference.

### TECHNICAL FIELD

The present technical field relates to electronic components, more particularly to an electronic component with an internal coil.

### BACKGROUND

As an disclosure relevant to a conventional electronic component, a multilayer chip inductor disclosed in, for example, Japanese Patent Laid-Open Publication No. 2001-358016, is known. FIG. 11 is an exploded oblique view of the multilayer chip inductor 500 disclosed in Japanese Patent Laid-Open Publication No. 2001-358016.

The multilayer chip inductor 500 includes a plurality of pieces of ferrite sheets 501, a plurality of coil conductors 502, and a plurality of through-hole conductors 503. The ferrite sheets 501 are rectangular sheets laminated to constitute a rectangular body of the multilayer chip inductor 500. The coil conductors 502 are provided on the ferrite sheets 501, and connected by the through-hole conductors 503 to constitute a helical coil.

Here, in the multilayer chip inductor 500, the coil conductors 502 are provided in pairs, each consisting of the coil conductors 502 that have the same shape and are connected in parallel. Therefore, the multilayer chip inductor 500 has a reduced direct-current resistance.

Incidentally, the multilayer chip inductor 500 disclosed in Japanese Patent Laid-Open Publication No. 2001-358016 might have defective connections at the through-hole conductors 503. Specifically, downstream ends of an upper pair of congruent coil conductors 502 are connected to upstream ends of a lower pair of congruent coil conductors 502 by a straight series of three through-hole conductors 503. The through-hole conductors 503 are formed by applying a conductor material to fill through-holes provided in the ferrite sheets 501. At this time, a very small amount of air is mixed into the conductors in the through-holes. That is, the conductors do not fill the through-holes densely. Therefore, in the case where multiple through-hole conductors 503 (in the case of the multilayer chip inductor 500, three through-hole conductors 503) are connected in a series, the through-hole conductors 503 are not sufficiently compressed upon pressure bonding of the ferrite sheets 501. As a result, gaps are created at the boundaries between the through-hole conductors 503 and the coil conductors 502. Consequently, defective connections might occur at the through-hole conductors 503.

### SUMMARY

An electronic component according to an embodiment of the present disclosure includes a laminate formed by laminating a plurality of insulator layers, a plurality of first coil conductors provided in the laminate so as to wind in a predetermined direction when viewed in a plan view in a direction of lamination, the first coil conductors having first parallel portions overlapping with one another when viewed in a plan view in the direction of lamination, a plurality of second coil conductors provided in the laminate on one side in the direction of lamination relative to the first coil conductors, so as to wind in the predetermined direction when viewed in a plan view in the direction of lamination, the second coil conductors having second parallel portions overlapping with one another when viewed in a plan view in the direction of lamination, first via-hole conductors that connect downstream ends of the first parallel portion in the predetermined direction, second via-hole conductors that connect downstream ends of the second parallel portions in the predetermined direction, and a third via-hole conductor that connects the farthest of the first coil conductors on one side in the direction of lamination to the farthest of the second coil conductors on the other side in the direction of lamination. The first through third via-hole conductors are not connected in a series.

### BRIEF DESCRIPTION OF THE DRAWINGS

FIG. 1 is an external perspective view of an electronic component according to an embodiment.

FIG. 2 is an exploded oblique view of the electronic component in FIG. 1.

FIG. 3 is a cross-sectional structure view of the electronic component taken along line A-A of FIG. 1.

FIG. 4 is a plan view of the electronic component during production.

FIG. 5 is a plan view of the electronic component during production.

FIG. 6 is a plan view of the electronic component during production.

FIG. 7 is a plan view of the electronic component during production.

FIG. 8 is a plan view of the electronic component during production.

FIG. 9 is a plan view of the electronic component during production.

FIG. 10 is an exploded oblique view of an electronic component according to a modification.

FIG. 11 is an exploded oblique view of a multilayer chip inductor disclosed in Japanese Patent Laid-Open Publication No. 2001-358016.

### DETAILED DESCRIPTION

Hereinafter, an electronic component according to an embodiment of the present disclosure will be described.

### Configuration of Electronic Component

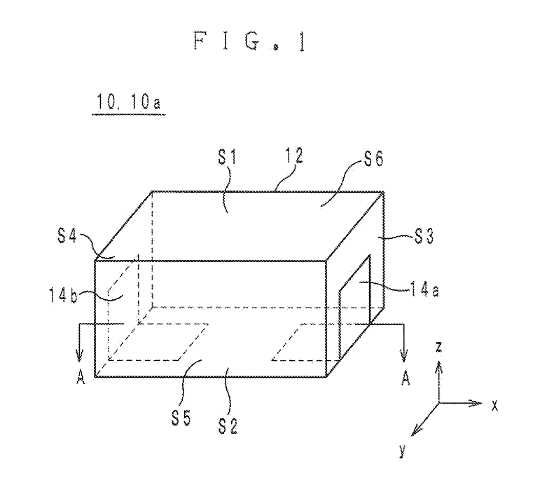

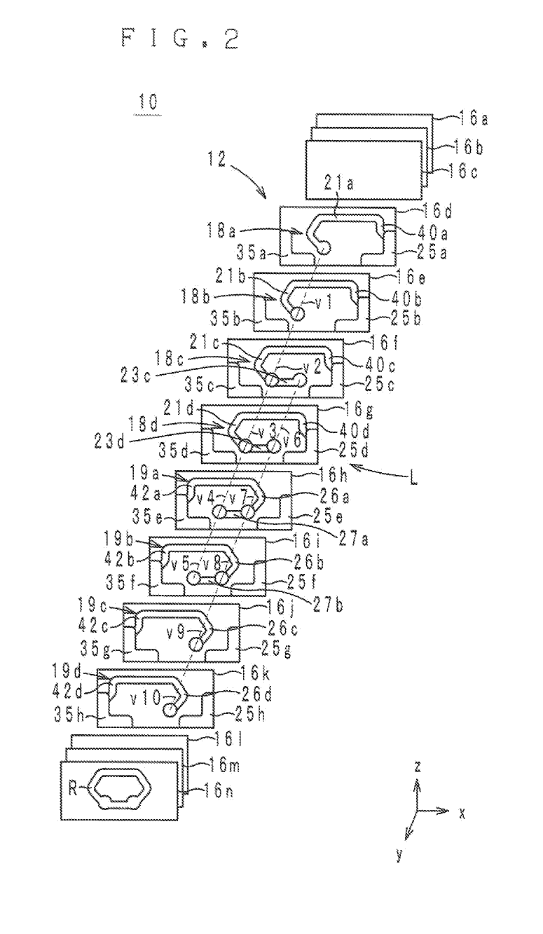

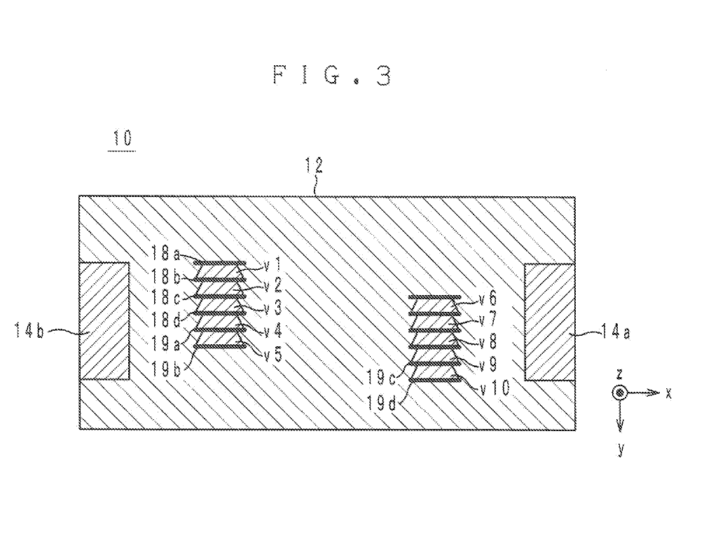

The configuration of the electronic component according to the embodiment will be described below with reference to the drawings. FIG. 1 is an external perspective view of the electronic component 10 according to the embodiment. FIG. 2 is an exploded oblique view of the electronic component 10 in FIG. 1. FIG. 3 is a cross-sectional structural view of the electronic component 10 taken along line A-A of FIG. 1. In the following, the direction of lamination of the electronic component 10 will be defined as a y-axis direction. In addition, when viewed in a plan view in the y-axis direction, the direction in which the long side of the electronic component 10 extends will be defined as an x-axis direction, and the direction in which the short side of the electronic component 10 extends will be defined as a z-axis direction.

As shown in FIGS. 1 and 2, the electronic component 10 includes a laminate 12, external electrodes 14a and 14b, lead-out conductors 40a to 40d and 42a to 42d, and a coil L (not shown in FIG. 1).

The laminate 12 is in the form of a rectangular solid formed by laminating a plurality of insulator layers 16a to 16n in this order, from the negative side to the positive side in the y-axis direction, as shown in FIG. 2. Accordingly, the laminate 12 has a top surface S1, a bottom surface S2, end surfaces S3 and S4, and side surfaces S5 and S6. The top surface S1 is a surface of the laminate 12 that is located on the positive side in the z-axis direction. The bottom surface S2 is a surface of the laminate 12 that is located on the negative side in the z-axis direction, and serves as a mounting surface to face a circuit board when the electronic component 10 is mounted on the circuit board. The top surface S1 is formed by a series of the long sides of the insulator layers 16a to 16n on the positive side in the z-axis direction, and the bottom surface S2 is formed by a series of the long sides of the insulator layers 16a to 16n on the negative side in the z-axis direction. The end surfaces S3 and S4 are surfaces of the laminate 12 that are located on the positive and negative sides, respectively, in the x-axis direction. The end surface S3 is formed by a series of the short sides of the insulator layers 16a to 16n on the positive side in the x-axis direction, and the end surface S4 is formed by a series of the short sides of the insulator layers 16a to 16n on the negative side in the x-axis direction. Moreover, the end surfaces S3 and S4 neighbor the bottom surface S2. The side surfaces S5 and S6 are surfaces of the laminate 12 that are located on the positive and negative sides, respectively, in the y-axis direction.

The insulator layers 16a to 16n are in the shape of rectangles, as shown in FIG. 2, and are made of, for example, an insulating material mainly composed of borosilicate glass. In the following, the surfaces of the insulator layers 16a to 16n that are located on the positive side in the y-axis direction will be referred to as front faces, and the surfaces of the insulator layers 16a to 16n that are located on the negative side in the y-axis direction will be referred to as back faces.

The coil L includes coil conductors 18a to 18d (first coil conductors), coil conductors 19a to 19d (second coil conductors), and via-hole conductors v1 to v10. The coil L, when viewed in a plan view from the positive side in the y-axis direction, spirals counterclockwise from the negative side toward the positive side in the y-axis direction. The coil conductors 18a to 18d are provided on the front faces of the insulator layers 16d to 16g. The coil conductors 19a to 19d are provided on the front faces of the insulator layers 16h to 16k. The coil conductors 18a to 18d and 19a to 19d, when viewed in a plan view in the y-axis direction, overlap with one another in the form of an annular path R. The path R is hexagonal. The coil conductors 18a to 18d and 19a to 19d will be described in more detail below.

Each of the coil conductors 18a and 18b (third coil conductors from the first coil conductors) has a length equivalent to three sides of the hexagonal path R, and winds counterclockwise when viewed in a plan view from the positive side in the y-axis direction. The coil conductors 18a and 18b have the same shape. Each of the coil conductors 18c and 18d (fourth coil conductors from the first coil conductors) has a length equivalent to four sides of the hexagonal path R, and winds counterclockwise when viewed in a plan view from the positive side in the y-axis direction. The coil conductors 18c and 18d have the same shape. The coil conductor 18c and 18d are provided on the positive side in the y-axis direction relative to the coil conductors 18a and 18d.

The coil conductors 18a to 18d, when viewed in a plan view in the y-axis direction, have their respective parallel portions 21a to 21d (first parallel portions) overlapping with one another. The coil conductors 18a and 18b entirely overlap with the coil conductors 18c and 18d. Accordingly, the parallel portions 21a and 21b constitute the entire coil conductors 18a and 18d, respectively.

Each of the coil conductors 18c and 18d overlaps with the coil conductors 18a and 18b along three upstream sides of the path R in the counterclockwise direction. The parallel portions 21c and 21d constitute parts of the coil conductors 18c and 18d, respectively, that coincide with the three upstream sides of the path R in the counterclockwise direction.

Furthermore, the coil conductors 18c and 18d have their respective parallel portions 23c and 23d (third parallel portions), which, when viewed in a plan view in the y-axis direction, overlap with each other on the downstream side in the counterclockwise direction relative to the parallel portions 21c and 21d. The coil conductors 18c and 18d overlap with each other along one downstream side of the path R in the counterclockwise direction. Accordingly, the parallel portions 23c and 23d constitute parts of the coil conductors 18c and 18d, respectively, that coincide with the one downstream side of the path R in the counterclockwise direction.

Each of the coil conductors 19a and 19b (fifth coil conductors from the second coil conductors) has a length equivalent to four sides of the hexagonal path R, and winds counterclockwise when viewed in a plan view from the positive side in the y-axis direction. The coil conductors 19a and 19b have the same shape. Each of the coil conductors 19c and 19d (sixth coil conductors from the second coil conductors) has a length equivalent to three sides of the hexagonal path R, and winds counterclockwise when viewed in a plan view from the positive side in the y-axis direction. The coil conductors 19c and 19d have the same shape. The coil conductors 19c and 19d are provided on the positive side in the y-axis direction relative to the coil conductors 19a and 19b.

The coil conductors 19a to 19d have their respective parallel portions 26a to 26d (second parallel portions), which, when viewed in a plan view in the y-axis direction, overlap with one another. The coil conductors 19c and 19d entirely overlap with the coil conductors 19a and 19b. Accordingly, the parallel portions 26c and 26d constitute the entire coil conductors 19c and 19d, respectively.

Each of the coil conductors 19a and 19b overlaps with the coil conductors 19c and 19d along three downstream sides of the path R in the counterclockwise direction. Accordingly, the parallel portions 26a and 26b constitute parts of the coil conductors 19a and 19b, respectively, that coincide with the three downstream sides of the path R in the counterclockwise direction.

Furthermore, the coil conductors 19a and 19b have their respective parallel portions 27a and 27b (fourth parallel portions), which, when viewed in a plan view in the y-axis direction, overlap with each other on the upstream side in the counterclockwise direction relative to the parallel portions 26a and 26b. The coil conductors 19a and 19b overlap with each other along one upstream side of the path R in the counterclockwise direction. Accordingly, the parallel portions 27a and 27b constitute parts of the coil conductors 19a and 19b, respectively, that coincide with the one upstream side of the path R in the counterclockwise direction.

Furthermore, the parallel portions 23c and 23d and the parallel portions 27a and 27b overlap with one another when viewed in a plan view in the y-axis direction.

The coil conductors 18a to 18d and 19a to 19d thus configured are made of, for example, a conductive material mainly composed of Ag.

The via-hole conductors v1 to v3 (first via-hole conductors) pierce through the insulator layers 16e to 16g, respectively, in the y-axis direction. The via-hole conductors v1 to v3 connect the downstream ends of the parallel portions 21a to 21d in the counterclockwise direction. More specifically, the via-hole conductor v1 connects the downstream ends of the parallel portions 21a and 21b in the counterclockwise direction. The via-hole conductor v2 connects the downstream ends of the parallel portions 21b and 21c in the counterclockwise direction. The via-hole conductor v3 connects the downstream ends of the parallel portion 21c and 21d in the counterclockwise direction.

The via-hole conductors v8 to v10 (second via-hole conductors) pierce through the insulator layers 16i to 16k, respectively, in the y-axis direction. The via-hole conductors v8 to v10 connect the upstream ends of the parallel portions 26a to 26d in the counterclockwise direction. More specifically, the via-hole conductor v8 connects the upstream ends of the parallel portions 26a and 26b in the counterclockwise direction. The via-hole conductor v9 connects the upstream ends of the parallel portions 26b and 26c in the counterclockwise direction. The via-hole conductor v10 connects the upstream ends of the parallel portions 26c and 26d in the counterclockwise direction.

The via-hole conductor v4 (third via-hole conductor) pierces through the insulator layer 16h in the y-axis direction. The via-hole conductor v4 connects the coil conductor 18d, which is the farthest of the first coil conductors on the positive side in the y-axis direction, to the coil conductor 19a, which is the farthest of the second coil conductors on the negative side in the y-axis direction. More specifically, the via-hole conductor v4 connects the upstream ends of the parallel portions 23d and 27a in the counterclockwise direction. Accordingly, the via-hole conductors v1 to v3, the via-hole conductors v8 to v10, and the via-hole conductor v4 are not connected in a series, as shown in FIG. 3.

The via-hole conductor v7 (fourth via-hole conductor) pierces through the insulator layer 16h in the y-axis direction. The via-hole conductor v7 connects the coil conductor 18d, which is the farthest of the first coil conductors on the positive side in the y-axis direction, to the coil conductor 19a, which is the farthest of the second coil conductors on the negative side in the y-axis direction. More specifically, the via-hole conductor v7 connects the downstream ends of the parallel portions 23d and 27a in the counterclockwise direction.

The via-hole conductor v6 (fifth via-hole conductor) pierces through the insulator layer 16g in the y-axis direction. The via-hole conductor v6 connects the coil conductors 18c and 18d. More specifically, the via-hole conductor v6 connects the downstream ends of the parallel portions 23c and 23d in the counterclockwise direction. Accordingly, the via-hole conductors v6 to v10 are connected in a series, as shown in FIG. 3.

The via-hole conductor v5 (sixth via-hole conductor) pierces through the insulator layer 16i in the y-axis direction. The via-hole conductor v5 connects the coil conductors 19a and 19b. More specifically, the via-hole conductor v5 connects the upstream ends of the parallel portions 27a and 27b in the counterclockwise direction. Accordingly, the via-hole conductors v1 to v5 are connected in a series, as shown in FIG. 3.

In the configuration as above, the via-hole conductors v1 to v5 and the via-hole conductors v6 to v10 are provided at different positions in the x-axis direction, as shown in FIG. 3, so that they are not connected in a series. The via-hole conductors v1 to v10 are made of, for example, a conductive material mainly composed of Ag.

As described above, the coil L includes the pairs of congruent coil conductors, i.e., the coil conductors 18a and 18d, the coil conductors 18c and 18d, the coil conductors 19a and 19b, and the coil conductors 19c and 19d. Moreover, the coil L has the four parallel portions 21a to 21d connected in parallel, the four parallel portions 23c, 23d, 27a, and 27b connected in parallel, and the four parallel portions 26a to 26d connected in parallel. That is, the coil L includes the sets of four parallel portions connected in parallel, which are arranged along the entire length of the coil.

The external electrode 14a is embedded in the bottom surface S2 and the end surface S3 of the laminate 12, which are formed by outer edges of the insulator layers 16a to 16n provided in a series, in an area including the intersection of the bottom surface S2 and the end surface S3, as shown in FIG. 1. Accordingly, the external electrode 14a, when viewed in a plan view in the y-axis direction, takes the form of an “L” shape. The external electrode 14a is formed by laminating external conductors 25a to 25h, as shown in FIG. 2.

The external conductor 25a is provided on the front face of the insulator layer 16d, as shown in FIG. 2. The external conductors 25b to 25h are provided in the insulator layers 16e to 16k, respectively, so as to be exposed on both faces in the y-axis direction, as shown in FIG. 2. The external conductors 25a to 25h are electrically connected through lamination. The external conductors 25a to 25h take the form of an “L” shape, and, when viewed in a plan view in the y-axis direction, they are positioned at the corners where the short sides of the insulator layers 16d to 16k that are located on the positive side in the x-axis direction intersect the long sides that are located on the negative side in the z-axis direction.

The external electrode 14b is embedded in the bottom surface S2 and the end surface S4 of the laminate 12, which is formed by outer edges of the insulator layers 16a to 16n provided in a series, in an area including the intersection of the bottom surface S2 and the end surface S4, as shown in FIG. 1. Accordingly, the external electrode 14b, when viewed in a plan view in the y-axis direction, takes the form of an “L” shape. The external electrode 14b is formed by laminating external conductors 35a to 35h, as shown in FIG. 2.

The external conductor 35a is provided on the front face of the insulator layer 16d, as shown in FIG. 2. The external conductors 35b to 35h are provided in the insulator layers 16e to 16k, respectively, so as to be exposed on both faces in the y-axis direction, as shown in FIG. 2. The external conductors 35a to 35h are electrically connected through lamination. The external conductors 35a to 35h take the form of an “L” shape, and, when viewed in a plan view in the y-axis direction, they are positioned at the corners where the short sides of the insulator layers 16d to 16k that are located on the negative side in the x-axis direction intersect the long sides that are located on the negative side in the z-axis direction.

Furthermore, the portions of the external electrodes 14a and 14b that are exposed to the outside of the laminate 12 are plated with Ni and Sn in order to have good solderability for mounting. Moreover, the insulator layers 16a to 16c and the insulator layers 16l to 16n are laminated on opposite sides of the external electrodes 14a and 14b in the y-axis direction. Accordingly, the external electrodes 14a and 14b are not exposed from the side surfaces S5 and S6.

The lead-out conductors 40a to 40d are respectively provided on the front faces of the insulator layers 16d to 16g, so as to connect the upstream ends of the coil conductors 18a to 18d in the counterclockwise direction to the external conductors 25a to 25d. Accordingly, the upstream end of the coil L in the counterclockwise direction is connected to the external electrode 14a.

The lead-out conductors 42a to 42d are respectively provided on the front faces of the insulator layers 16h to 16k, so as to connect the downstream ends of the coil conductors 19a to 19d in the counterclockwise direction to the external conductors 35e to 35h. Accordingly, the downstream end of the coil L in the counterclockwise direction is connected to the external electrode 14b.

### Method for Producing Electronic Component

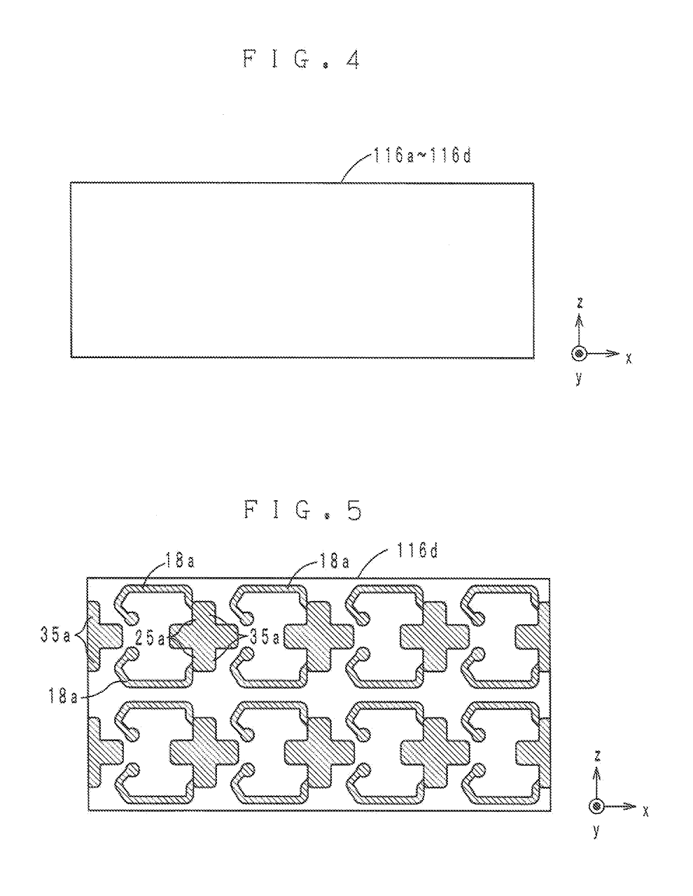

The method for producing the electronic component 10 according to the present embodiment will be described below with reference to the drawings. FIGS. 4 through 9 are plan views of the electronic component 10 during production.

Initially, an insulating paste mainly composed of borosilicate glass is repeatedly applied by screen printing, thereby forming insulating paste layers 116a to 116d, as shown in FIG. 4. The insulating paste layers 116a to 116d are outer insulator layers positioned outside relative to the coil L and serving as insulator layers 16a to 16d.

Next, coil conductors 18a and external conductors 25a and 35a are formed by photolithography, as shown in FIG. 5. Specifically, a photosensitive, conductive paste whose main metal component is Ag is applied to the insulating paste layer 116d by screen printing, thereby forming a conductive paste layer on the insulating paste layer 116d. In addition, the conductive paste layer is irradiated with ultraviolet light or suchlike through a photomask, and developed by an alkaline solution or suchlike. As a result, the external conductors 25a and 35a and the coil conductors 18a are formed on the insulating paste layer 116d.

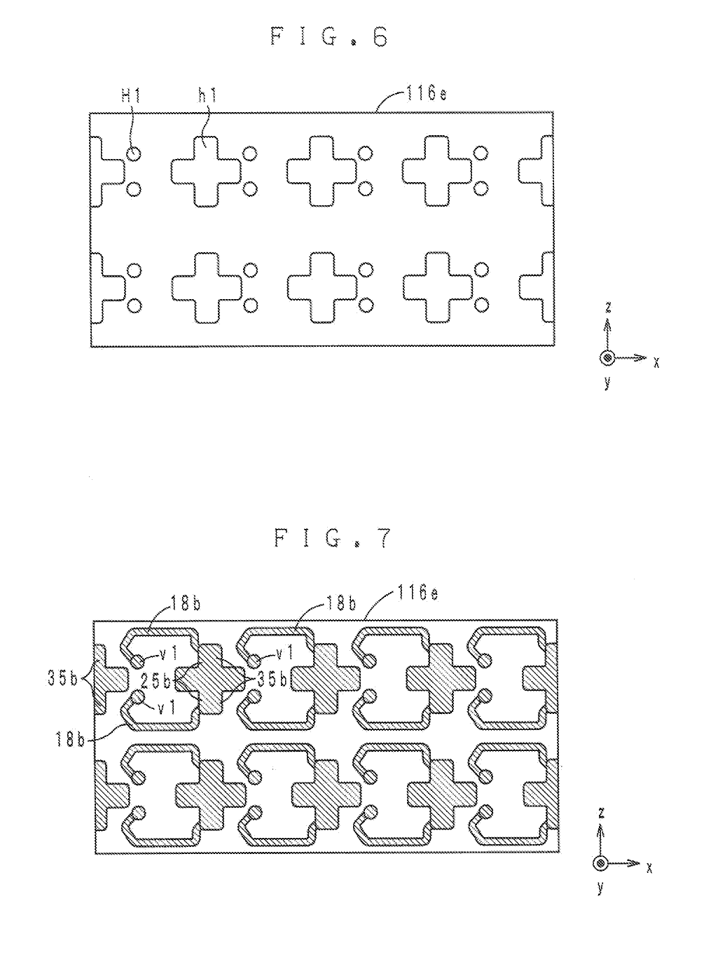

Next, an insulating paste layer 116e with openings h1 and via-holes H1 is formed by photolithography, as shown in FIG. 6. Specifically, a photosensitive, insulating paste is applied to the insulating paste layer 116d by screen printing, thereby forming an insulating paste layer on the insulating paste layer 116d. In addition, the insulating paste layer is irradiated with ultraviolet light or suchlike through a photomask, and developed by an alkaline solution or suchlike. The insulating paste layer 116e is a paste layer serving as an insulator layer 16e. The opening h1 is a cross-shaped hole in which two external conductors 25b and two external conductors 35b are joined.

Next, coil conductors 18d, external conductors 25b and 35b, and via-hole conductors v1 are formed by photolithography, as shown in FIG. 7. Specifically, a photosensitive, conductive paste whose main metal component is Ag is applied to the insulating paste layer 116e by screen printing, thereby forming a conductive paste layer on the insulating paste layer 116e so as to fill the openings h1 and the via-holes H1. In addition, the conductive paste layer is irradiated with ultraviolet light or suchlike through a photomask, and developed by an alkaline solution or suchlike. As a result, the external conductors 25b and 35b are formed in the openings h1, the via-hole conductors v1 are formed in the via-holes H1, and the coil conductors 18b are formed on the insulating paste layer 116e.

Thereafter, the same steps as shown in FIGS. 6 and 7 are repeated to form insulating paste layers 116f to 116k, coil conductors 18c, 18d, and 19a to 19d, external conductors 25c to 25h and 35c to 35h, and via-hole conductors v2 to v10. As a result, the coil conductors 19d and the external conductors 25h and 35h are formed on the insulating paste layer 116k, as shown in FIG. 8.

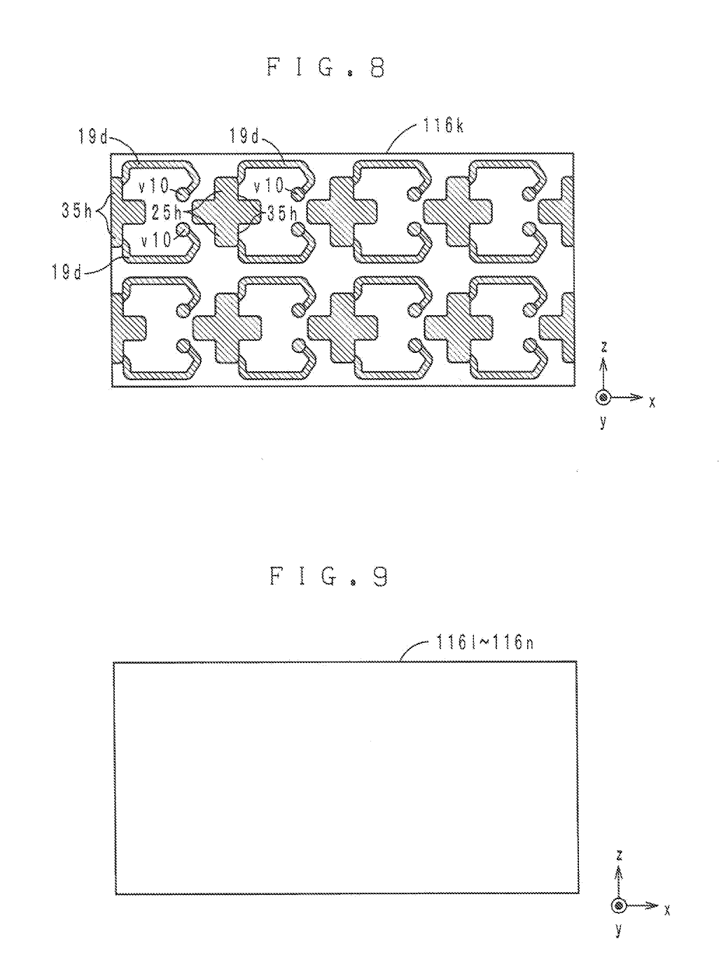

Next, an insulating paste is repeatedly applied by screen printing, thereby forming insulating paste layers 116l to 116n, as shown in FIG. 9. The insulating paste layers 116l to 116n are outer insulator layers positioned outside relative to the coil L and serving as insulator layers 16l to 16n. Through the above steps, a mother laminate 112 is obtained.

Next, the mother laminate 112 is cut into a plurality of unsintered laminates 12 by dicing or suchlike. In the step of cutting the mother laminate 112, the external electrodes 14a and 14b are exposed from the laminates 12 at edges made by the cutting.

Next, the unsintered laminates 12 are sintered under predetermined conditions. In addition, the sintered laminates 12 are barreled for beveling.

Lastly, the laminates 12 are plated with Sn and Ni, each to a thickness of 2 μm to 7 μm, where the external electrodes 14a and 14b are exposed. By the foregoing process, the electronic component 10 is completed.

### Effects

The electronic component 10 thus configured renders it possible to reduce the direct-current resistance of the coil L. More specifically, the coil conductors 18a to 18d have their respective parallel portions 21a to 21d connected in parallel. Further, the coil conductors 18c, 18d, 19a, and 19b have their respective parallel portions 23c, 23d, 27a, and 27b connected in parallel. Further still, the coil conductors 19a to 19d have their respective parallel portions 26a to 26d connected in parallel. Thus, the direct-current resistance of the coil L can be reduced.

Furthermore, the electronic component 10 renders it possible to inhibit occurrence of defective connections at the via-hole conductors v1 to v10. More specifically, the multilayer chip inductor 500 disclosed in Japanese Patent Laid-Open Publication No. 2000-358016 might have defective connections at the through-hole conductors 503. The downstream ends of an upper pair of congruent coil conductors 502 are connected to the upstream ends of a lower pair of congruent coil conductors 502 by a straight series of three through-hole conductors 503. Accordingly, defective connections might occur at the through-hole conductors 503.

On the other hand, in the case of the electronic component 10, the via-hole conductors v1 to v3, which connect the coil conductors 18a to 18d, the via-hole conductors v8 to v10, which connect the coil conductors 19a to 19d, and the via-hole conductors v4 and v5, which connect the coil conductors 18d and 19a, are not connected in a series. That is, the coil conductors 18a to 18d, which have approximately the same shape, and the coil conductors 19a to 19d, which have approximately the same shape, are not connected by a series of via-hole conductors. Therefore, the electronic component 10 renders it possible to inhibit occurrence of defective connections at the via-hole conductors v1 to v10.

Furthermore, the coil L includes sets of four parallel portions connected in parallel, which are arranged along the entire length of the coil. This results in an increased Q-factor of the coil L.

### Modification

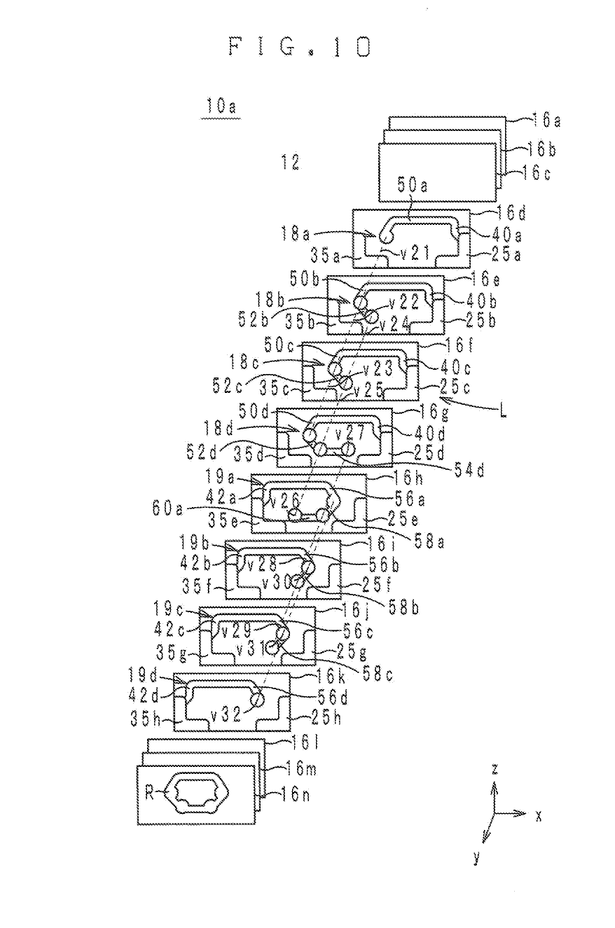

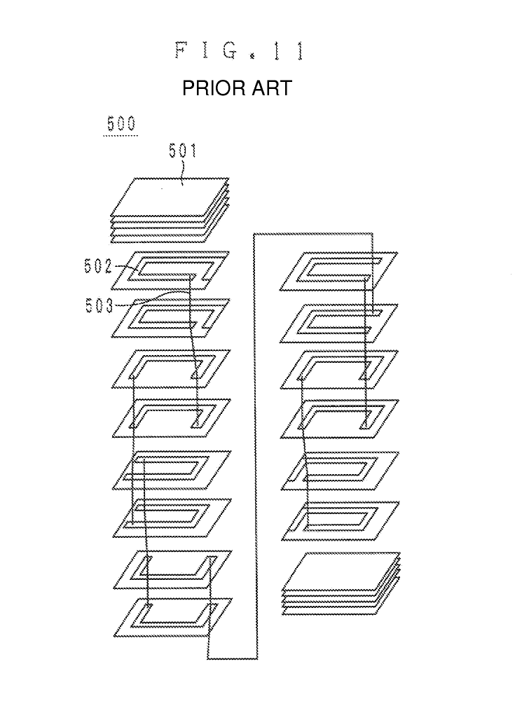

Next, an electronic component 10a according to a modification will be described with reference to the drawings. FIG. 10 is an exploded oblique view of the electronic component 10a according to the modification.

The electronic component 10a differs from the electronic component 10 in terms of the shape of the coil conductors 18a to 18d and 19a to 19d and the position of the via-hole conductors v21 to v32. The electronic component 10a will be described below, mainly focusing on the coil conductors 18a to 18d and 19a to 19d and the via-hole conductors v21 to v32.

The coil L consists of the coil conductors 18a to 18d (first coil conductors) and 19a to 19d (second coil conductors) and the via-hole conductors v21 to v32, and, when viewed in a plan view from the positive side in the y-axis direction, it spirals counterclockwise from the negative side toward the positive side in the y-axis direction. The coil conductors 18a to 18d are provided on the front faces of the insulator layers 16d to 16g. The coil conductors 19a to 19d are provided on the front faces of the insulator layers 16h to 16k. The coil conductors 18a to 18d and 19a to 19d, when viewed in a plan view in the y-axis direction, overlap with one another in the form of an annular path R. The path R is hexagonal. The coil conductors 18a to 18d and 19a to 19d will be described in more detail below.

The coil conductor 18a has a length equivalent to two sides of the hexagonal path R, and winds counterclockwise when viewed in a plan view from the positive side in the y-axis direction. Each of the coil conductors 18b and 18c has a length equivalent to three sides of the hexagonal path R, and winds counterclockwise when viewed in a plan view from the positive side in the y-axis direction. The coil conductors 18b and 18c have the same shape. The coil conductor 18d has a length equivalent to four sides of the hexagonal path R, and winds counterclockwise when viewed in a plan view from the positive side in the y-axis direction.

The coil conductors 18a to 18d have their respective parallel portions 50a to 50d, which overlap with one another when viewed in a plan view in the y-axis direction. The coil conductor 18a entirely overlaps with the coil conductors 18b to 18d. Accordingly, the parallel portion 50a constitutes the entire coil conductor 18a.

Each of the coil conductors 18b to 18d overlaps with the coil conductor 18a along two upstream sides of the path R in the counterclockwise direction. Accordingly, the parallel portions 50b to 50d constitute parts of the coil conductors 18b to 18d, respectively, that coincide with the two upstream sides of the path R in the counterclockwise direction.

Furthermore, the coil conductors 18b to 18d have their respective parallel portions 52b to 52d, which, when viewed in a plan view in the y-axis direction, overlap with one another on the downstream side in the counterclockwise direction relative to the parallel portions 50b to 50d. Accordingly, the coil conductors 18b to 18d also overlap with one another along one downstream side of the path R in the counterclockwise direction relative to the parallel portions 50b to 50d. Therefore, the parallel portions 52b to 52d constitute parts of the coil conductors 18b to 18d, respectively, that coincide with the one downstream side of the path R in the counterclockwise direction relative to the parallel portions 50b to 50d.

Furthermore, the coil conductor 18d has a parallel portion 54d, which, when viewed in a plan view in the y-axis direction, is located on the downstream side in the counterclockwise direction relative to the parallel portion 52d. The parallel portion 54d constitutes a part of the coil conductor 18d that coincides with one downstream side of the path R in the counterclockwise direction relative to the parallel portion 52d.

The coil conductor 19a has a length equivalent to four sides of the hexagonal path R, and winds counterclockwise when viewed in a plan view from the positive side in the y-axis direction. Each of the coil conductors 19b and 19c has a length equivalent to three sides of the hexagonal path R, and winds counterclockwise when viewed in a plan view from the positive side in the y-axis direction. The coil conductors 19b and 19c have the same shape. The coil conductor 19d has a length equivalent to two sides of the hexagonal path R, and winds counterclockwise when viewed in a plan view from the positive side in the y-axis direction.

The coil conductors 19a to 19d have their respective parallel portions 56a to 56d, which overlap with one another when viewed in a plan view in the y-axis direction. The coil conductor 19d entirely overlaps with the coil conductors 19a to 19c. Accordingly, the parallel portion 56d constitutes the entire coil conductor 19d.

Each of the coil conductors 19a to 19c overlaps with the coil conductor 19d along two downstream sides of the path R in the counterclockwise direction. Accordingly, the parallel portions 56a to 56c constitute parts of the coil conductors 19a to 19c, respectively, that coincide with the two downstream sides of the path R in the counterclockwise direction.

Furthermore, the coil conductors 19a to 19c have their respective parallel portions 58a to 58c, which, when viewed in a plan view in the y-axis direction, overlap with one another on the upstream side in the counterclockwise direction relative to the parallel portions 56a to 56c. The coil conductors 19a to 19c overlap with one another along one upstream side of the path R in the counterclockwise direction relative to the parallel portions 56a to 56c. Accordingly, the parallel portions 58a to 58c constitute parts of the coil conductors 19a to 19c, respectively, that coincide with the one upstream side of the path R in the counterclockwise direction relative to the parallel portions 56a to 56c.

Furthermore, the coil conductor 19a has a parallel portion 60a, which is located on the upstream side in the counterclockwise direction relative to the parallel portion 58a when viewed in a plan view in the y-axis direction. The parallel portion 60a constitutes a part of the coil conductor 19a that coincides with one upstream side of the path R in the counterclockwise direction relative to the parallel portion 58a.

Furthermore, the parallel portions 54d and 60a overlap with each other when viewed in a plan view in the y-axis direction.

The coil conductors 18a to 18d and 19a to 19d thus configured are made of, for example, a conductive material mainly composed of Ag.

The via-hole conductors v21 to v23 (first via-hole conductors) pierce through the insulator layers 16e to 16g, respectively, in the y-axis direction. The via-hole conductors v21 to v23 connect the downstream ends of the parallel portions 50a to 50d in the counterclockwise direction.

The via-hole conductors v30 to v32 (second via-hole conductors) pierce through the insulator layers 16i to 16k, respectively, in the y-axis direction. The via-hole conductors v30 to v32 connect the upstream ends of the parallel portions 56a to 56d in the counterclockwise direction.

The via-hole conductor v26 (third via-hole conductor) pierces through the insulator layer 16h in the y-axis direction. The via-hole conductor v26 connects the coil conductor 18d, which is the farthest of the first coil conductors on the positive side in the y-axis direction, to the coil conductor 19a, which is the farthest of the second coil conductors on the negative side in the y-axis direction. More specifically, the via-hole conductor v26 connects the upstream ends of the parallel portions 54d and 60a in the counterclockwise direction. Accordingly, the via-hole conductors v21 to v23, the via-hole conductors v30 to v32, and the via-hole conductor v26 are not connected in a series, as shown in FIG. 10.

The via-hole conductor v27 pierces through the insulator layer 16h in the y-axis direction. The via-hole conductor v27 connects the coil conductor 18d, which is located at the furthermost end on the positive side in the y-axis direction, to the coil conductor 19a, which is located at the furthermost end on the negative side in the y-axis direction. More specifically, the via-hole conductor v27 connects the downstream ends of the parallel portions 54d and 60a in the counterclockwise direction.

The via-hole conductors v24 and v25 pierce through the insulator layers 16f and 16g, respectively, in the y-axis direction. The via-hole conductor v24 connects the coil conductors 18b and 18c. More specifically, the via-hole conductor v24 connects the downstream ends of the parallel portions 52b and 52c in the counterclockwise direction. In addition, the via-hole conductor v25 connects the coil conductors 18c and 18d. More specifically, the via-hole conductor v25 connects the downstream ends of the parallel portions 52c and 52d in the counterclockwise direction. Accordingly, the via-hole conductors v24 to v26 are connected in a series, as shown in FIG. 10.

The via-hole conductors v28 and v29 pierce through the insulator layers 16i and 16j, respectively, in the y-axis direction. The via-hole conductor v28 connects the coil conductors 19a and 19b. More specifically, the via-hole conductor v28 connects the upstream ends of the parallel portions 58a and 58b in the counterclockwise direction. In addition, the via-hole conductor v29 connects the coil conductors 19b and 19c. More specifically, the via-hole conductor v29 connects the upstream ends of the parallel portions 58b and 58c in the counterclockwise direction. Accordingly, the via-hole conductors v27 to v29 are connected in a series, as shown in FIG. 10.

In the configuration as above, the via-hole conductors v21 to v23, the via-hole conductors v24 to v26, the via-hole conductors v27 to v29, and the via-hole conductors v30 to v32 are provided at different positions in the x-axis direction, as shown in FIG. 10, so that they are not connected in a series. The via-hole conductors v21 to v32 are made of, for example, a conductive material mainly composed of Ag.

### Effects

The electronic component 10a thus configured, as with the electronic component 10, renders it possible to reduce the direct-current resistance of the coil L, and also to inhibit occurrence of defective connections at the via-hole conductors v21 to v32.

Furthermore, the electronic component 10a has fewer via-holes connected in a series than the electronic component 10. Thus, the electronic component 10a renders it possible to more effectively inhibit occurrence of defective connections at the via-hole conductors v21 to v32 than the electronic component 10.

### Other Embodiments

The present disclosure is not limited to the electronic components 10 and 10a according to the above embodiment, and variations can be made within the spirit and scope of the disclosure.

Furthermore, for the electronic components 10 and 10a, the insulating paste layers 116 are formed by photolithography, but they may be formed by screen printing.

Furthermore, for each of the electronic components 10 and 10a, the coil L includes two groups of coil conductors, i.e., the coil conductors 18a to 18d and the coil conductors 19a to 19d, but it may include three or more groups of coil conductors. In such a case, the relationship between two adjacent groups of coil conductors is similar to the relationship between the coil conductors 18a to 18d and the coil conductors 19a to 19d.

Although the present disclosure has been described in connection with the preferred embodiment above, it is to be noted that various changes and modifications are possible to those who are skilled in the art. Such changes and modifications are to be understood as being within the scope of the disclosure.

What is claimed is:

1. An electronic component comprising:
a laminate formed by laminating a plurality of insulator layers;
a plurality of first coil conductors provided in the laminate so as to wind in a predetermined direction when viewed in a plan view in a direction of lamination, the first coil conductors having first parallel portions overlapping with one another when viewed in a plan view in the direction of lamination;
a plurality of second coil conductors provided in the laminate on one side in the direction of lamination relative to the first coil conductors so as to wind in the predetermined direction when viewed in a plan view in the direction of lamination, the second coil conductors having second parallel portions overlapping with one another when viewed in a plan view in the direction of lamination;
first via-hole conductors connecting downstream ends of the first parallel portions in the predetermined direction;
second via-hole conductors connecting downstream ends of the second parallel portions in the predetermined direction; and
a third via-hole conductor connecting a farthest of the first coil conductors on one side in the direction of lamination to a farthest of the second coil conductors on the other side in the direction of lamination, wherein,
the first through third via-hole conductors are not connected in a series.

2. The electronic component according to claim 1, wherein,
the first coil conductors include:
a plurality of third coil conductors; and
a plurality of fourth coil conductors provided on a first side in the direction of lamination relative to the third coil conductors and having third parallel portions overlapping with one another on a downstream side in the predetermined direction relative to the first parallel portions when viewed in a plan view in the direction of lamination,
the second coil conductors include:
a plurality of fifth coil conductors, and
a plurality of sixth coil conductors provided on a second side in the direction of lamination relative to the fifth coil conductors and having fourth parallel portions overlapping with one another on an upstream side in the predetermined direction relative to the second parallel portions when viewed in a plan view in the direction of lamination,
the third parallel portions and the fourth parallel portions overlap with each other when viewed in a plan view in the direction of lamination,
the third via-hole conductor connects upstream ends of the third and fourth parallel portions in the predetermined direction, and
the electronic component further includes:
a fourth via-hole conductor that connects downstream ends of the third and fourth parallel portions in the predetermined direction;
a fifth via-hole conductor that connects downstream ends of the third parallel portions; and
a sixth via-hole conductor that connects upstream ends of the fourth parallel portions.

3. The electronic component according to claim 2, wherein,
the first via-hole conductors, the third via-hole conductor, and the sixth via-hole conductor are connected in a series, and
the second via-hole conductors, the fourth via-hole conductor, and the fifth via-hole conductor are connected in a series.

4. The electronic component according to claim 2, wherein the third coil conductors, the fourth coil conductors, the fifth coil conductors, and the sixth coil conductors are equal in number.

5. The electronic component according to claim 1, further comprising:
a first external electrode connected to the first coil conductors; and
a second external electrode connected to the second coil conductors.

6. The electronic component according to claim 3, wherein the third coil conductors, the fourth coil conductors, the fifth coil conductors, and the sixth coil conductors are equal in number.

7. The electronic component according to claim 2, further comprising:
a first external electrode connected to the first coil conductors; and
a second external electrode connected to the second coil conductors.

8. The electronic component according to claim 3, further comprising:
a first external electrode connected to the first coil conductors; and
a second external electrode connected to the second coil conductors.

9. The electronic component according to claim 4, further comprising:
a first external electrode connected to the first coil conductors; and
a second external electrode connected to the second coil conductors.
